(19) United States
(12) Patent Application Publication
(10) Pub. No.: US 2026/0369543 A1
(43) Pub. Date: Nov. 19, 2026

(54) METHOD FOR MANUFACTURING ELECTRODE ASSEMBLY

(71) Applicant: HONDA MOTOR CO., LTD., Tokyo (JP)

(72) Inventors: Kenta Kasano, Wako-shi (JP); Shohei Yoshida, Wako-shi (JP)

(21) Appl. No.: 19/543,892

(22) Filed: Feb. 19, 2026

(30) Foreign Application Priority Data
Mar. 24, 2025 (JP) 2025-048852

(51) Int. Cl. H01M 4/04; H01M 4/02; H01M 4/62; H01M 4/70

(52) U.S. Cl. CPC H01M 4/0404; H01M 4/0409; H01M 4/62; H01M 4/70; H01M 2004/021

(57) ABSTRACT

A method for manufacturing an electrode assembly has a first step of identifying a sign provided on one surface of the base material and applying a slurry onto one surface of the base material based on information that is contained in the sign to form a first electrode layer, a second step of identifying the sign and applying an insulating layer along a periphery of the first electrode layer on the one surface of the base material based on information that is contained in the sign, and a third step of identifying the sign and applying a slurry to a position that overlaps the first electrode layer, which is formed on the one surface of the base material, at the other surface of the base material based on information that is contained in the sign to form a second electrode layer.

### CROSS-REFERENCE TO RELATED APPLICATION

Priority is claimed on Japanese Patent Application No. 2025-048852, filed Mar. 24, 2025, the content of which is incorporated herein by reference.

### BACKGROUND OF THE INVENTION

### Field of the Invention

The present invention relates to a method for manufacturing an electrode assembly.

### Description of Related Art

An electrode assembly having at least a positive electrode layer, an electrolyte layer, and a negative electrode layer is manufactured by, for example, applying materials (slurries) that form the positive electrode layer, the electrolyte layer, and the negative electrode layer, respectively, onto one surface of a base material that is continuously transported.

In Japanese Unexamined Patent Application, First Publication No. 2013-107053, it is described that when an electrode agent is applied to both surfaces of a web, such as a long metal foil, a pair of an upper die and a lower die are disposed in a transport path of the web that is horizontally transported, and the electrode agent is ejected onto both surfaces of the web from the upper die and the lower die.

Japanese Patent No. 4090781 describes an intermittent coating pitch measuring and inspecting device that can be suitably used in an application of measuring the intermittent coating pitches or the like of active material layers formed by intermittently applying active materials to an electrode core material and inspecting the quality thereof at the time of producing a positive electrode plate and a negative electrode plate for a battery by performing a drying step and a rolling step after the active materials are intermittently applied onto a single surface or both surfaces of the core material.

Japanese Patent No. 4838543 describes a transport device of a double-sided coated base material that grips both ends of the base material at all times and controls the tension state to be maintained to prevent the flapping of the base material and mitigate the impact of an inhibiting factor during the formation of coated surfaces immediately after the coating of both surfaces of the base material that is continuously transported.

### SUMMARY OF THE INVENTION

In the case of manufacturing an electrode assembly by forming electrode layers on both surfaces of a base material and manufacturing a battery using the electrode assembly, the electrode layers formed on both surfaces of the base material, respectively, need to completely overlap each other when seen from one surface or the other surface of the base material. When the electrode layers do not completely overlap each other (are misaligned), the performance of the battery may deteriorate.

However, in the case of applying slurries to form electrode layers onto both surfaces of a base material that is continuously transported, there is a problem in that it is difficult to accurately control the position where a slurry begins to be applied on the other surface of the base material, the amount of the slurry to be applied, the area of the slurry to be applied, or the like to match the position of an electrode layer formed on one surface of the base material.

An aspect of the present invention provides a method for manufacturing an electrode assembly in which it is possible to accurately control the position where a slurry begins to be applied on the other surface of a base material, the amount of the slurry to be applied, the area of the slurry to be applied, or the like to match the position of an electrode layer formed on one surface of the base material in the case of applying the slurry to form the other electrode layer onto one surface of the base material that is continuously transported. The aspect of the present invention contributes to the stabilization of battery performance, quality control improvement in manufacturing steps, and energy efficiencies.

The present invention has the following aspects.

[1] A method for manufacturing an electrode assembly that intermittently forms electrode layers on both surfaces of a base material that is continuously transported, the method having:
a first step of identifying a sign provided on one surface of the base material and applying a slurry containing an electrode active material onto one surface of the base material based on information that is contained in the sign to form a first electrode layer,
a second step of identifying the sign and applying an insulating layer along a periphery of the first electrode layer on the one surface of the base material based on information that is contained in the sign, and
a third step of identifying the sign and applying a slurry containing an electrode active material to a position that overlaps the first electrode layer, which is formed on the one surface of the base material, at the other surface of the base material based on information that is contained in the sign to form a second electrode layer.

According to the aspect, since it is possible to accurately control the positions where a slurry begins to be applied, the amount of the slurry to be applied, the area of the slurry to be applied, or the like on one surface and the other surface of a base material in the case of intermittently forming electrode layers on both surfaces of the base material that is continuously transported, it is possible to overlap the electrode layers formed on the one surface of the base material and the electrode layers formed on the other surface of the base material without misalignment when seen from the one surface or the other surface of the base material.

[2] The method for manufacturing an electrode assembly according to [1], in which the base material is a current collector foil.

According to the aspect, since the base material is a current collector foil, the electrode layers formed on both surfaces of the base material can be used without transferring the electrode layers to members for different electrodes, and it is possible to simplify the manufacturing steps of the electrode assembly.

[3] The method for manufacturing an electrode assembly according to [1] or [2], in which positioning marks that indicate positions where the slurry and the insulating layer begin to be applied are provided before and after the sign in a transport direction of the base material.

According to the aspect, it is possible to accurately determine the positions where the slurry begins to be applied even in a case where the sign is a barcode, an QR code, or the like.

[4] The method for manufacturing an electrode assembly according to any one of [1] to [3], the method further having: a fourth step of ending application of the slurries to the one surface and the other surface of the base material based on the information that is contained in the sign and removing surpluses of the slurries with an air knife.

According to the aspect, the surpluses of the slurries are blown away and removed with the air knife, whereby it is possible to curb the shapes of the electrode layers being distorted due to the flows of the slurries.

[5] The method for manufacturing an electrode assembly according to any one of [1] to [4], the method further having: a fifth step of excluding the electrode assembly as a defective product in a case where misalignment between the first electrode layer and the second electrode layer is a predetermined extent or more when seen from the one surface or the other surface of the base material.

According to the aspect, it is possible to collect only quality electrode assemblies.

According to the aspects of the present invention, it is possible to provide a method for manufacturing an electrode assembly in which it is possible to accurately control the position where a slurry begins to be applied on the other surface of a base material, the amount of the slurry to be applied, the area of the slurry to be applied, or the like to match the position of an electrode layer formed on one surface of the base material in the case of applying the slurry to form the other electrode layer onto one surface of the base material that is continuously transported.

### BRIEF DESCRIPTION OF THE DRAWINGS

FIG. 1 is a perspective view for describing a method for manufacturing an electrode assembly according to one embodiment of the present invention.

FIG. 2 is a perspective view for describing the method for manufacturing an electrode assembly according to one embodiment of the present invention.

FIG. 3 illustrates a base material that is used in the method for manufacturing an electrode assembly according to one embodiment of the present invention, and part (b) of FIG. 3 is an enlarged view of a part of part (a) of FIG. 3.

### DETAILED DESCRIPTION OF THE INVENTION

Hereinafter, an embodiment of the present invention will be described in detail with reference to drawings.

### Method for Manufacturing Electrode Assembly

A method for manufacturing an electrode assembly of the present embodiment is a method for manufacturing an electrode assembly that intermittently forms electrode layers on both surfaces of a base material that is continuously transported, the method having a first step of identifying a sign provided on one surface of the base material and applying a slurry containing an electrode active material onto one surface of the base material based on information that is contained in the sign to form a first electrode layer, a second step of identifying the sign and applying an insulating layer along a periphery of the first electrode layer on the one surface of the base material based on information that is contained in the sign, and a third step of identifying the sign and applying a slurry containing an electrode active material to a position that overlaps the first electrode layer, which is formed on the one surface of the base material, at the other surface of the base material based on information that is contained in the sign to form a second electrode layer.

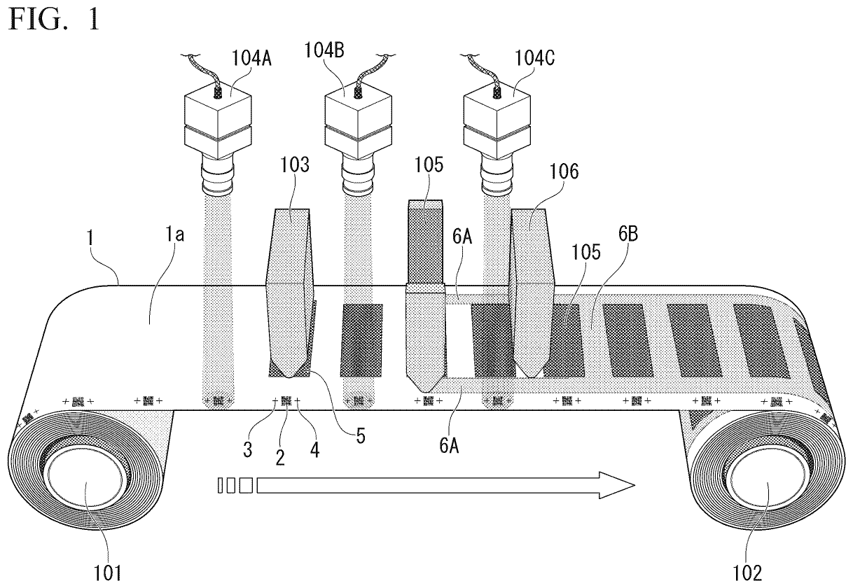

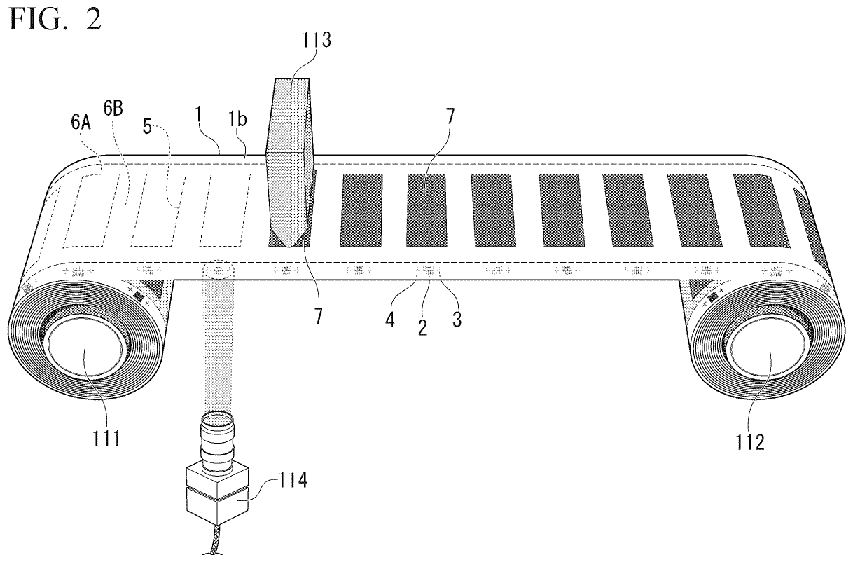

FIG. 1 and FIG. 2 are perspective views for describing the method for manufacturing an electrode assembly according to one embodiment of the present invention.

As illustrated in FIG. 1, in the method for manufacturing an electrode assembly of the present embodiment, for example, a long sheet-like base material 1 is continuously transported with two rotating rollers 101 and 102 disposed at a predetermined interval. In FIG. 1, the base material 1 is transported in an arrow direction.

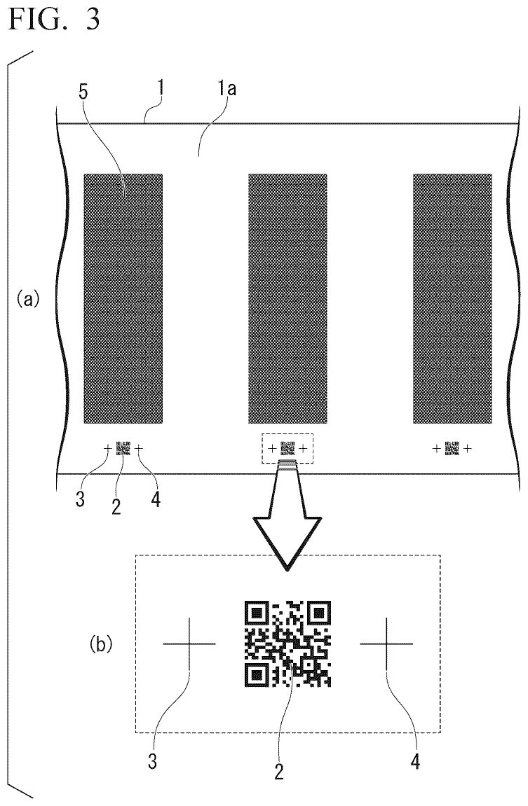

As illustrated in FIG. 1 and FIG. 3, on one surface 1a of the base material 1, signs 2 are intermittently provided in an edge portion of the base material 1 in the longitudinal direction (the transport direction of the base material 1). In other words, on the one surface 1a of the base material 1, the signs 2 are provided at positions corresponding to positions at which electrode layers are provided. The signs 2 contain information of positions where the slurry containing an electrode active material begins to be applied to the one surface of the base material, the amount of the slurry to be applied, the area of the slurry to be applied, or the like. In addition, the sign 2 contains information of positions where the insulating layer begins to be applied to the one surface of the base material, the amount of the insulating layer to be applied, the area of the insulating layer to be applied, or the like. As the sign 2, it is possible to use, for example, a barcode, an QR code, or the like. The signs 2 are provided on the one surface 1a of the base material 1 in advance before the slurry is applied.

As illustrated in FIG. 3, on the one surface 1a of the base material 1, positioning marks 3 and 4 that indicate the positions where the slurry begins to be applied are provided before and after the sign 2 in the longitudinal direction of the base material 1 (the transport direction of the base material 1). In a case where the signs 2 are barcodes, QR codes, or the like, it is difficult to accurately determine the positions where the slurry begins to be applied, and the positioning marks 3 and 4 are thus provided to assist the signs 2. As the positioning marks 3 and 4, it is possible to use, for example, crosses, Braille, star signs, or the like.

### First Step

In the first step, the slurry containing an electrode active material is applied onto the one surface 1a of the base material 1 that is continuously transported with a first coating device 103 to form first electrode layers 5. In the first step, before the application of the slurry with the first coating device 103, signs 2 provided on the one surface 1a of the base material 1 are identified with an identification device 104A, such as a camera, and the slurry is applied onto the one surface 1a of the base material 1 based on information that is contained in the signs 2 to form the first electrode layers 5. The identification device 104A identifies the signs 2 and also identifies the positioning marks 3 and 4. Therefore, the positions where the slurry begins to be applied to the one surface 1a of the base material 1, the amount of the slurry to be applied, the area of the slurry to be applied, or the like is controlled.

The base material 1 is not particularly limited as long as the slurry can be applied onto the base material 1, but is preferably a current collector foil since the current collector foil can be used as a part of an electrode assembly without transferring the first electrode layers 5 formed on the one surface 1a of the base material 1 to members for different electrodes and is capable of simplifying the manufacturing steps of the electrode assembly.

In a case where the first electrode layer 5 is a positive electrode layer, the slurry contains a positive electrode active material that gives and receives lithium ions and electrons, an electrolyte that gives and receives lithium ions to and from the positive electrode active material, and a solvent that disperses the positive electrode active material.

The positive electrode active material is not particularly limited as long as the positive electrode active material is capable of reversibly releasing and absorbing lithium ions and capable of performing electron transport, and well-known positive electrode active materials that can be applied to positive electrodes in lithium-ion batteries can be used. Examples thereof include composite oxides, such as lithium cobalt oxide (LiCoO₂), lithium nickel oxide (LiNiO₂), lithium manganese oxide (LiMn₂O₄), solid solution oxides (Li₂MnO₃—LiMO₂ (M=Co, Ni, or the like)), lithium-manganese-nickel-cobalt oxides (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, Li—Cu—S compounds, TiS₂, FeS, MoS₂, and Li—Mo—S compounds; mixtures of sulfur and carbon; and the like. The positive electrode active material may be composed of one of the above-described materials or may be composed of two or more thereof.

The electrolyte is not particularly limited as long as the electrolyte has lithium-ion conductivity, and it is possible to use a material that is generally used in lithium-ion batteries. Examples of the electrolyte include inorganic solid electrolytes such as sulfide solid electrolyte materials, oxide solid electrolyte materials, halide solid electrolytes, and lithium-containing salts, polymer-based solid electrolytes such as polyethylene oxide, and gel-based solid electrolytes containing a lithium-containing salt or a lithium-ion conductive ionic liquid, and the like. Among these, sulfide solid electrolyte materials are preferable from the viewpoint of highly conductive characteristics of lithium ions and favorable structural formability by pressing and interfacial bondability.

The electrolyte may be composed of one of the above-described materials only or may be composed of two or more thereof. The electrolyte that is contained in a first active material layer may be the same material as or a different material from an electrolyte that is contained in a second active material layer or a solid electrolyte layer.

A material that forms the positive electrode active material layer may contain a conductive auxiliary agent from the viewpoint of improving the conductivity of the positive electrode. As the conductive auxiliary agent, it is possible to use a conductive auxiliary agent that can be generally used in lithium-ion batteries. Examples thereof include carbon black such as acetylene black and Ketjen black; carbon fiber; vapor grown carbon fiber; graphite powder; and carbon materials such as carbon nanotubes. The conductive auxiliary agent may be composed of one of the above-described materials only or may be composed of two or more thereof.

As the solvent, it is possible to use, for example, butyl butyrate or the like.

In a case where the first electrode layer 5 is a negative electrode layer, the slurry preferably contains a negative electrode active material that gives and receives lithium ions and electrons, an electrolyte that gives and receives lithium ions to and from the negative electrode active material, and a solvent that disperses the negative electrode active material.

The negative electrode active material is not particularly limited as long as the negative electrode active material is a material capable of reversibly releasing and absorbing lithium ions and capable of electron transport, and it is possible to use a known negative electrode active material that can be applied to negative electrodes in lithium-ion batteries. Examples thereof include carbonaceous materials such as natural graphite, artificial graphite, resin carbon, carbon fiber, activated carbon, hard carbon, and soft carbon; alloy-based materials mainly composed of tin, a tin alloy, silicon, a silicon alloy, gallium, a gallium alloy, indium, an indium alloy, aluminum, an aluminum alloy, or the like; conductive polymers such as polyacene, polyacetylene, and polypyrrole; metallic lithium; and lithium alloys such as lithium titanium composite oxides (for example, Li₄Ti₅O₁₂). These negative electrode active materials may be composed of one of the above-described materials only or may be composed of two or more thereof.

The electrolyte is not particularly limited as long as the electrolyte has lithium-ion conductivity, and it is possible to use a material that is generally used in lithium-ion batteries. Examples of the electrolyte include inorganic solid electrolytes such as sulfide solid electrolyte materials, oxide solid electrolyte materials, halide solid electrolytes, and lithium-containing salts, polymer-based solid electrolytes such as polyethylene oxide, and gel-based solid electrolytes containing a lithium-containing salt or a lithium-ion conductive ionic liquid, and the like. The electrolyte may be composed of one of the above-described materials only or may be composed of two or more thereof.

The electrolyte that is contained in the second active material layer may be the same material as or a different material from the electrolyte that is contained in the first active material layer or the solid electrolyte layer.

A material that forms the negative electrode active material layer may contain, like the material that forms the positive electrode active material layer, a conductive auxiliary agent from the viewpoint of improving the conductivity of a negative electrode.

### Fourth Step

The method for manufacturing an electrode assembly of the present embodiment may have a fourth step of ending the application of the slurry to the one surface 1a of the base material 1 based on the information that is contained in the signs 2 and removing surpluses of the slurry with an air knife.

The amount of the slurry applied to the one surface 1a of the base material 1 with the first coating device 103 is controlled based on the information that is contained in the signs 2; however, when the fourth step is provided to end the application of the slurry to the one surface 1a of the base material 1 and blow away and remove surpluses of the slurry with the air knife, it is possible to curb the shapes of the first electrode layers 5 being distorted due to the flow of the slurry.

### Second Step

In the second step, before the application of an insulating layer with a second coating device 105, the signs 2 provided on the one surface 1a of the base material 1 are identified with an identification device 104B, and insulating layers 6A are applied along the edges of the first electrode layers 5 in the width direction (the longitudinal direction of the base material 1 or the transport direction of the base material 1) on the one surface 1a of the base material 1 based on the information that is contained in the signs 2. The identification device 104B identifies the signs 2 and also identifies the positioning marks 3 and 4. Therefore, the positions where the insulating layer 6A begins to be applied to the one surface 1a of the base material 1, the amount of the insulating layer 6A to be applied, the area of the insulating layer 6A to be applied, or the like is controlled.

In the second step, furthermore, before the application of an insulating layer with a third coating device 106, the signs 2 provided on the one surface 1a of the base material 1 are identified with an identification device 104C, and insulating layers 6B are applied along the edges of the first electrode layers 5 in the length direction (a direction orthogonal to the longitudinal direction of the base material 1 or a direction orthogonal to the transport direction of the base material 1) on the one surface 1a of the base material 1 based on the information that is contained in the signs 2. The identification device 104C identifies the signs 2 and also identifies the positioning marks 3 and 4. Therefore, the positions where the insulating layer 6B begins to be applied to the one surface 1a of the base material 1, the amount of the insulating layer 6B to be applied, the area of the insulating layer 6B to be applied, or the like is controlled.

### Sixth Step

The method for manufacturing an electrode assembly of the present embodiment may have a sixth step of drying the first electrode layers 5 formed in the first step and the insulating layers 6A and 6B formed in the second step. For the drying, a drying furnace or the like can be used.

### Third Step

In the third step, as illustrated in FIG. 2, the base material 1 having the first electrode layers 5 and the insulating layers 6A and 6B obtained by the above-described first step and second step is turned over, and for example, the long base material 1 is continuously transported with two rotating rollers 111 and 112 disposed at a predetermined interval. In FIG. 2, the base material 1 is transported in an arrow direction.

In the third step, a slurry containing an electrode active material is applied onto the other surface 1b of the base material 1 that is continuously transported with a fourth coating device 113 to form second electrode layers 7. In the third step, before the application of the slurry with the fourth coating device 113, the signs 2 provided on the one surface 1a of the base material 1 are identified with an identification device 114, such as a camera, the slurry containing the electrode active material is applied to positions that overlap the first electrode layers 5 formed on the one surface 1a of the base material 1 on the other surface 1b of the base material 1 based on the information that is contained in the signs 2 to form the second electrode layers 7. The identification device 114 identifies the signs 2 and also identifies the positioning marks 3 and 4. Therefore, the positions where the slurry begins to be applied to the other surface 1b of the base material 1, the amount of the slurry to be applied, the area of the slurry to be applied, or the like is controlled. In the third step, as in the first step, the signs 2 provided on the one surface 1a of the base material 1 are identified. Therefore, even on the other surface 1b of the base material 1, it is possible to control the positions where the slurry begins to be applied to the other surface 1b of the base material 1, the amount of the slurry to be applied, the area of the slurry to be applied, or the like in the same manner as in the application to the one surface 1a of the base material 1.

As the slurry, the same slurry as in the first step can be used.

The method for manufacturing an electrode assembly of the present embodiment may have the above-described fourth step after the third step.

### Seventh Step

The method for manufacturing an electrode assembly of the present embodiment may have a seventh step of drying the second electrode layers 7 formed in the fourth step. For the drying, a drying furnace or the like can be used.

An electrode assembly in which the first electrode layers 5 are intermittently formed on the one surface 1a of the base material 1 and the second electrode layers 7 are formed on the other surface 1b of the base material 1 to overlap the first electrode layer 5 in the thickness direction of the base material 1 can be obtained by the above-described steps. The obtained electrode assembly is cut to predetermined widths and lengths and then collected.

### Fifth Step

The method for manufacturing an electrode assembly of the present embodiment preferably has a fifth step of excluding the electrode assembly as a defective product in a case where misalignment between the first electrode layer 5 and the second electrode layer 7 is a predetermined extent or more when seen from the one surface 1a or the other surface 1b of the base material 1. For the detection of misalignment, a diagnostic image device including a camera or the like can be used. This makes it possible to collect only quality electrode assemblies.

According to the method for manufacturing an electrode assembly of the present embodiment, in the case of intermittently forming electrode layers on both surfaces of the base material that is continuously transported, it is possible to overlap the electrode layers formed on the one surface of the base material and the electrode layers formed on the other surface of the base material without misalignment when seen from the one surface or the other surface of the base material.

In the method for manufacturing an electrode assembly of the present embodiment, the case where the base material 1 having the first electrode layers 5 and the insulating layers 6A and 6B is turned over after the end of the second step, and the third step is then performed has been exemplified, but the present invention is not limited thereto. In the present invention, the first step through the third step may be continuously performed.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A method for manufacturing an electrode assembly that intermittently forms electrode layers on both surfaces of a base material that is continuously transported, the method comprising:
a first step of identifying a sign provided on one surface of the base material and applying a slurry containing an electrode active material onto one surface of the base material based on information that is contained in the sign to form a first electrode layer,
a second step of identifying the sign and applying an insulating layer along a periphery of the first electrode layer on the one surface of the base material based on information that is contained in the sign, and
a third step of identifying the sign and applying a slurry containing an electrode active material to a position that overlaps the first electrode layer, which is formed on the one surface of the base material, at the other surface of the base material based on information that is contained in the sign to form a second electrode layer.

2. The method for manufacturing an electrode assembly according to claim 1, wherein the base material is a current collector foil.

3. The method for manufacturing an electrode assembly according to claim 1, wherein positioning marks that indicate positions where the slurry and the insulating layer begin to be applied are provided before and after the sign in a transport direction of the base material.

4. The method for manufacturing an electrode assembly according to claim 1, the method further comprising:
a fourth step of ending application of the slurries to the one surface and the other surface of the base material based on the information that is contained in the sign and removing surpluses of the slurries with an air knife.

5. The method for manufacturing an electrode assembly according to claim 1, the method further comprising:
a fifth step of excluding the electrode assembly as a defective product in a case where misalignment between the first electrode layer and the second electrode layer is a predetermined extent or more when seen from the one surface or the other surface of the base material.
